(19) United States
(12) Patent Application Publication
(10) Pub. No.: US 2010/0251226 A1
(43) Pub. Date: Sep. 30, 2010

(54) COMPILE METHOD, COMPUTER PROGRAM PRODUCT, AND SEMICONDUCTOR-INTEGRATED-CIRCUIT MANUFACTURING METHOD

(75) Inventors: Makoto Sato, Kanagawa (JP); Katsuya Uchida, Tokyo (JP); Hiroyuki Tsukahara, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/685,056

(22) Filed: Jan. 11, 2010

(30) Foreign Application Priority Data
Mar. 27, 2009 (JP) 2009-078094

(51) Int. Cl. G06F 9/45; G06F 9/44

(52) U.S. Cl. 717/146; 717/140; 717/104

(57) ABSTRACT

A first execution program for outputting coverage data during execution is output by compiling a first source code. Coverage data is output by executing the output first execution program. A code block not executed at all included in the first source code is commented out or deleted according to the output coverage data to generate a second source code. A second execution program is output by compiling the generated second source code.

### CROSS-REFERENCE TO RELATED APPLICATIONS

This application is based upon and claims the benefit of priority from the prior Japanese Patent Application No. 2009-078094, filed on Mar. 27, 2009; the entire contents of which are incorporated herein by reference.

### BACKGROUND OF THE INVENTION

1. Field of the Invention

The present invention relates to a compile method, a computer program product, and a semiconductor-integrated-circuit manufacturing method.

2. Description of the Related Art

In general, some compiler has a function of “dead code optimization” for deleting an unexecuted instruction and a meaningless instruction according to a result obtained by statically analyzing a source code. For example, an instruction described after an instruction for ending a function (when the instruction is not a branch destination from other places), a definition of a variable referred to from nowhere, and the like are objects of optimization.

The following is an example of a source code written in the C language:

Row number: Instruction
1: int foo( )
2: {
3: int a=1;
4: int b;
5: int c;
6: c=a*2;
7: return c;
8: b=5;
9: }

In this example, because an instruction for substituting 5 in b in the eighth row is described after a RETURN statement, the instruction is an unexecuted invalid instruction and can be deleted. Because the eighth row can be deleted, a variable b defined in the fourth row is referred to from nowhere. This means that this code row can also be deleted. Deleting a dead code not affecting a result of a computer program from a result of a static analysis is dead code optimization of a compiler in the past. This technology is simply referred to as technology in the past below. When dead code optimization processing is executed, various preferable effects such as a reduction in size of an execution program to be generated, an increase in execution speed, and a reduction in memory capacity in use can be obtained.

Japanese Patent Application Laid-Open No. 2003-196106 discloses a technology obtained by expanding the technology in the past. With the technology, rather than determining in instruction units whether an instruction is a dead code, if there is a meaningless parameter among a plurality of parameters to be passed when a method is invoked, the meaningless parameter is deleted. In the method to be invoked, an instruction concerning the deleted parameter can also be deleted.

However, in some case, depending on a parameter that dynamically changes during execution, the operation of a program following the parameter changes and, as a result, an instruction not executed at all is included in a source code. In the technology in the past and the technology disclosed in Japanese Patent Application Laid-Open No. 2003-196106, because it is determined based on a static analysis whether an instruction is a dead code, the instruction not executed at all as a result cannot be specified as a dead code. In other words, with the technology in the past and the technology disclosed in Japanese Patent Application Laid-Open No. 2003-196106, efficient compilation cannot be performed because such an instruction cannot be deleted.

Besides, there is a compiler optimizing method based on execution result information of a computer program (e.g., “Optimization of a Profile Base”, [on line], Hewlett-Packard Japan, Ltd., [searched on Mar. 18, 2008], Internet <URL: http://docs.hp.com/ja/B2355-90732/ch08s03.html> and “an optimization option of a profile base +Oprofile”, [online], Hewlett-Packard Japan, Ltd., [searched on Mar. 18, 2008], Internet <URL: http://docs.hp.com/ja/5185-6571/ch01s09.html>). However, with this method, a dead code cannot be deleted, although an arrangement position of a function can be changed and code generation for a branching statement based on branch prediction can be changed.

### BRIEF SUMMARY OF THE INVENTION

A compile method according to an embodiment of the present invention comprises:

outputting a first execution program for outputting coverage data during execution by compiling a first source code;

outputting the coverage data by executing the output first execution program;

generating a second source code, according to the output coverage data, by commenting out or deleting a code block not executed at all included in the first source code; and

outputting a second execution program by compiling the generated second source code.

A computer program product according to an embodiment of the present invention including a plurality of instructions executable by a computer, the instructions cause the computer to execute:

outputting a first execution program for outputting coverage data during execution by compiling a first source code;

outputting the coverage data by executing the output first execution program;

generating a second source code, according to the output coverage data, by commenting out or deleting a code block not executed at all included in the first source code; and

outputting a second execution program by compiling the generated second source code.

A semiconductor-integrated-circuit manufacturing method according to an embodiment of the present invention comprises:

outputting a first execution program for outputting coverage data during execution by compiling a first design model for a semiconductor integrated circuit described in a programming language;

outputting the coverage data by executing the output first execution program;

generating a second design model, according to the output coverage data, by commenting out or deleting a code block not executed at all included in the first design model;

outputting a second execution program by compiling the generated second design model;

verifying the second design model by executing the output second execution program;

creating, according to the verified second design model, an analog circuit design diagram for the semiconductor integrated circuit; and

manufacturing the semiconductor integrated circuit according to the created analog circuit design.

### BRIEF DESCRIPTION OF THE DRAWINGS

FIG. 1 is a diagram for explaining the functional configuration of a compile apparatus according to a first embodiment of the present invention;

FIG. 2 is a diagram for explaining the hardware configuration of the compile apparatus according to the first embodiment;

FIG. 3 is a flowchart for explaining a compile method according to the first embodiment;

FIG. 4 is a diagram for explaining an example of coverage data;

FIG. 5 is a flowchart for explaining processing for generating dead code information;

FIG. 6 is a diagram for explaining an example of dead code information;

FIG. 7 is a flowchart for explaining processing for preventing an invalid code block from functioning;

FIG. 8 is a diagram for explaining an example of description of #pragma;

FIG. 9 is a diagram of an example of a source code subjected to dead code optimization;

FIG. 10 is a diagram of an example of a source code subjected to dead code optimization; and

FIG. 11 is a flowchart for explaining an example of a procedure for designing and manufacturing a semiconductor integrated circuit using System C.

### DETAILED DESCRIPTION OF THE INVENTION

Exemplary embodiments of a compile method, a computer program product, and a semiconductor-integrated-circuit manufacturing method according to the present invention will be explained below in detail with reference to the accompanying drawings. The present invention is not limited to the following embodiments.

A compile method according to a first embodiment of the present invention includes a first stage for applying first compilation to a source code (a first source code) and outputting an execution program (a first execution program) for outputting coverage data during execution, a second stage for executing the execution program and acquiring the coverage data; a third stage for performing, according to the acquired coverage data, dead code optimization processing for comment-out or deletion of an invalid code block not executed at all from the source code and generating a source code (a second source code) subjected to the dead code optimization processing; and a fourth stage for compiling the source code subjected to the dead code optimization processing (second compilation) and outputting an execution program subjected to dead code optimization (a second execution program).

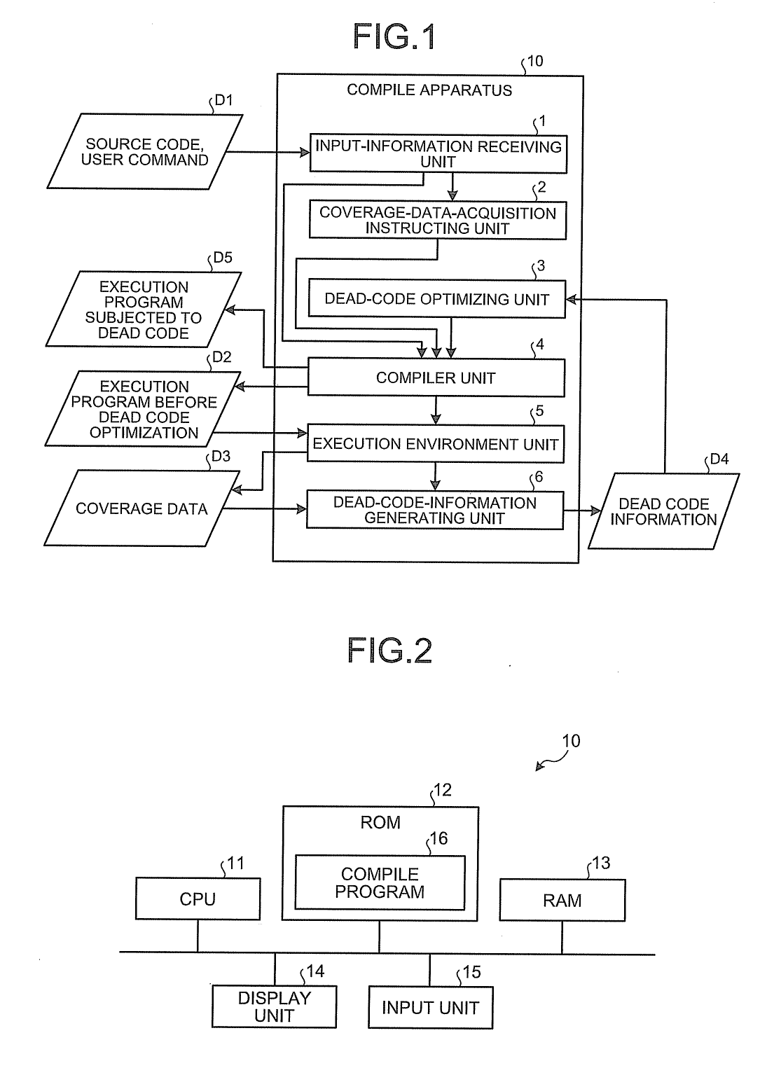

FIG. 1 is a diagram for explaining the functional configuration of a compile apparatus for realizing the compile method according to the first embodiment. The C language is explained below as an example of a programming language treated in the first embodiment. However, the present invention can be applied to programming languages other than the C language. A compile apparatus 10 shown in FIG. 1 includes an input-information receiving unit 1, a coverage-data-acquisition instructing unit 2, a dead-code optimizing unit 3, a compiler unit 4, an execution environment unit 5, and a dead-code-information generating unit 6.

The input-information receiving unit 1 receives input information D1 including a source code and a user command from an external storage device or the like. The input user command includes an option command for instructing acquisition of coverage data (a coverage data acquisition instruction) and an option command for instructing to perform dead code optimization. In the option for instructing dead code optimization, it is possible to designate whether an invalid code block included in the source code should be commented out or deleted from the source code. When “DEADCODE_OPT_MODE=1” is included in the user command, the invalid code block is commented our. When “DEADCODE_OPT_MODE=2” is included in the user command, the invalid code block is deleted.

The coverage-data-acquisition instructing unit 2 sets, according to the user command, Makefile as a condition setting file for compilation. Specifically, the coverage-data-acquisition instructing unit 2 performs, in Makefile for performing first compilation, setting for generating an execution file for outputting coverage data. The coverage-data-acquisition instructing unit 2 performs, in Makefile for second compilation, setting for generating an execution file for not outputting coverage data. The coverage-data-acquisition instructing unit 2 passes the Makefile after the setting to the compiler unit 4.

The dead-code optimizing unit 3 performs, according to dead code information D4 as information indicating an invalid code block generated by the dead-code-information generating unit 6, dead code optimization processing for commenting out or deleting an invalid code block from a source code and passes the source code after the optimization processing to the compiler unit 4.

The compiler unit 4 executes compilation. Specifically, the compiler unit 4 compiles (first compilation), according to the Makefile set to generate an execution file for outputting coverage data, the source code received by the input-information receiving unit 1 and outputs an execution program before dead code optimization D2. The compiler unit 4 compiles (second compilation), according to the Makefile set to generate an execution file for not outputting coverage data and outputs an execution program subjected to dead code optimization D5.

The execution environment unit 5 outputs coverage data D3 by executing the execution program before dead code optimization D2.

The dead-code-information generating unit 6 extracts, according to the coverage data D3 output by the execution environment unit 5, an invalid code block in the source code and outputs the extracted invalid code block as dead code information D4.

FIG. 2 is a diagram for explaining the hardware configuration of the compile apparatus 10. As shown in the figure, the compile apparatus 10 has a computer configuration including a central processing unit (CPU) 11, a read only memory (ROM) 12, a random access memory (RAM) 13, a display unit 14, and an input unit 15. The devices are connected to one another via a bus line.

The CPU 11 executes a compile program 16 as a computer program for executing the compile method according to the first embodiment. The display unit 14 is a display device such as a liquid crystal monitor. The display unit 14 displays, according to an instruction from the CPU 11, output information for a user such as an operation screen. The input unit 15 includes a mouse and a keyboard. The operation of the compile apparatus 10 from the user is input to the input unit 15. Operation information input to the input unit 15 is sent to the CPU 11.

The compile program 16 is stored in the ROM 12 and loaded to the RAM 13 via the bus line. The CPU 11 executes the compile program 16 loaded in the RAM 13. Specifically, in the compile apparatus 10, the CPU 11 reads out the compile program 16 from the ROM 12, expands the compile program 16 in a program storage area in the RAM 13, and executes various kinds of processing according to an instruction input from the input unit 15 by the user. The input information D1 is input from an external storage device or the like. The CPU 11 executes the various kinds of processing according to the input information D1 input from the external storage device or the like. The CPU 11 temporarily stores, in a data storage area formed in the RAM 13, data generated in the various kinds of processing, i.e., the Makefile for first compilation and second compilation, the execution program before dead code optimization D2, the coverage data D3, the dead code information D4, and other work data. The CPU 11 outputs the execution program subjected to dead code optimization D5, which is created by using the data temporarily stored in the data storage area, to the program storage area in the RAM 13 and the external storage device or the like. The compile program 16 can be stored in a storage device such as a disk or can be loaded.

The compile program 16 executed by the compile apparatus 10 according to the first embodiment generates the input-information receiving unit 1, the coverage-data-acquisition instructing unit 2, the dead-code optimizing unit 3, the compiler unit 4, the execution environment unit 5, and the dead-code-information generating unit 6 on a main storage device.

The compile program 16 can be stored on a computer connected to a network such as the Internet and provided or distributed by being downloaded through the network. The compile program 16 can be incorporated in a ROM or the like in advance and provided to the compile apparatus 10.

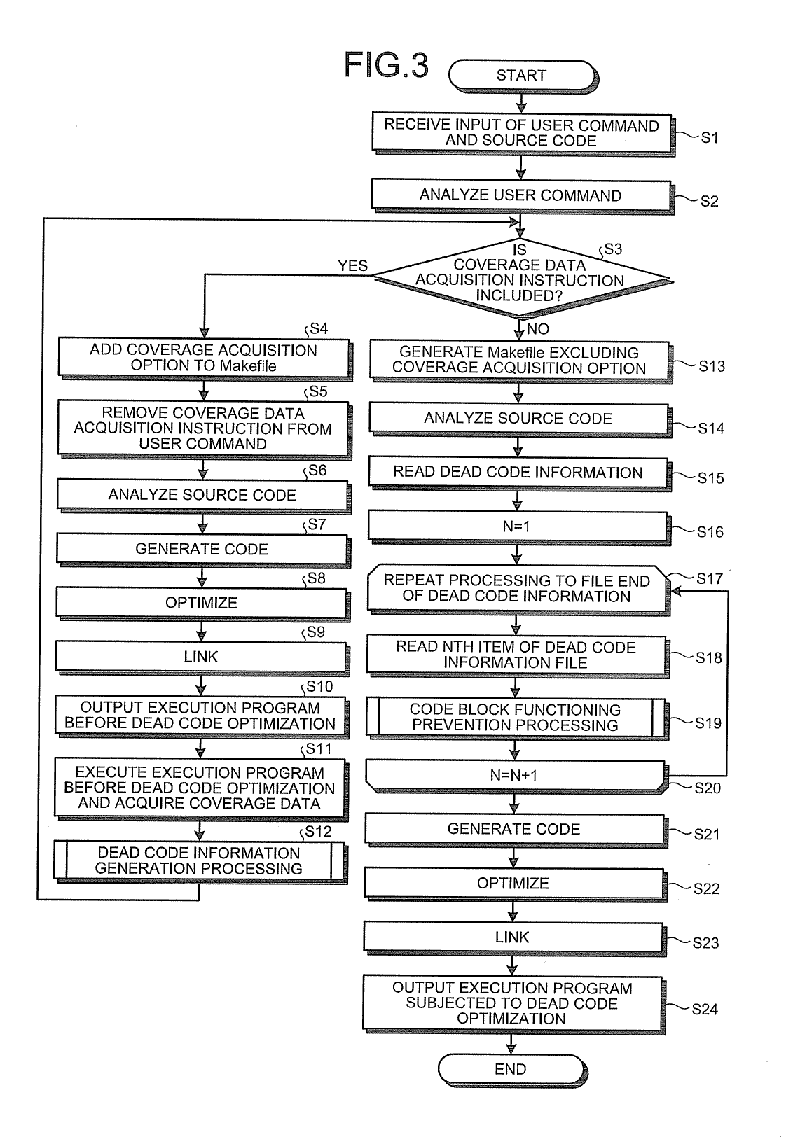

FIG. 3 is a flowchart for explaining the compile method according to the first embodiment.

At steps S1 to S10, processing up to the output of the execution program before dead code optimization D2 is executed (a first stage). Specifically, first, the input-information receiving unit 1 receives the input of the input information D1 including a user command and a source code (S1). A user inputs a user command including a coverage data acquisition instruction and an option command for instructing to perform dead code optimization. The coverage-data-acquisition instructing unit 2 analyzes the input user command (S2) and determines whether the coverage data acquisition instruction is included in the user command (S3).

Because the coverage data acquisition instruction is included in the input user command, the processing shifts to step S4. The coverage-data-acquisition instructing unit 2 creates Makefile added with an option for acquiring coverage data (coverage acquisition option) (S4) and deletes the coverage data acquisition instruction from the input user command (S5).

Subsequently, the compiler unit 4 expands the input source code on the RAM 13, performs an analysis of the expanded source code (S6), and executes first compilation according to an analysis result and the Makefile added with the coverage acquisition option (S7 to S10). The compiler unit 4 generates an object code from the source code expanded on the RAM 13 (S7). The compiler unit 4 optimizes the generated code (S8), links a file necessary for execution with the optimized code (S9), and outputs the code after the link processing as the execution program before dead code optimization D2 (S10). Unlike the dead code optimization according to the first embodiment, the optimization at step S8 is a generally-known optimization applied to the code after generation. Because a series of compile operation of the compiler unit 4 is the same as a generally-available compiler, more detailed explanation of the compile operation is omitted.

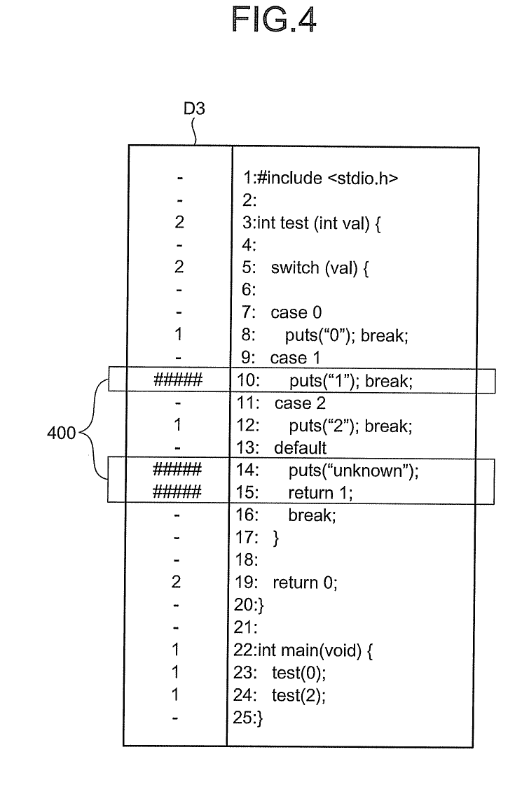

At step S11, coverage data is acquired (a second stage). The execution environment unit 5 executes the execution program before dead code optimization D2 and acquires the coverage data D3 (S11). FIG. 4 is a diagram for explaining an example of the coverage data D3. The coverage data D3 shown in FIG. 4 has a form in which the number of times of execution in the execution environment unit 5 is added for each row of the source code. Rows in which the number of times of execution is 0 (rows marked by # in FIG. 4 (reference numeral 400)) is unexecuted invalid code blocks.

At steps S12 to S20, invalid code blocks not executed at all are commented out or deleted from the source code (a third stage). After step S11, the dead-code-information generating unit 6 generates the dead code information D4 (S12).

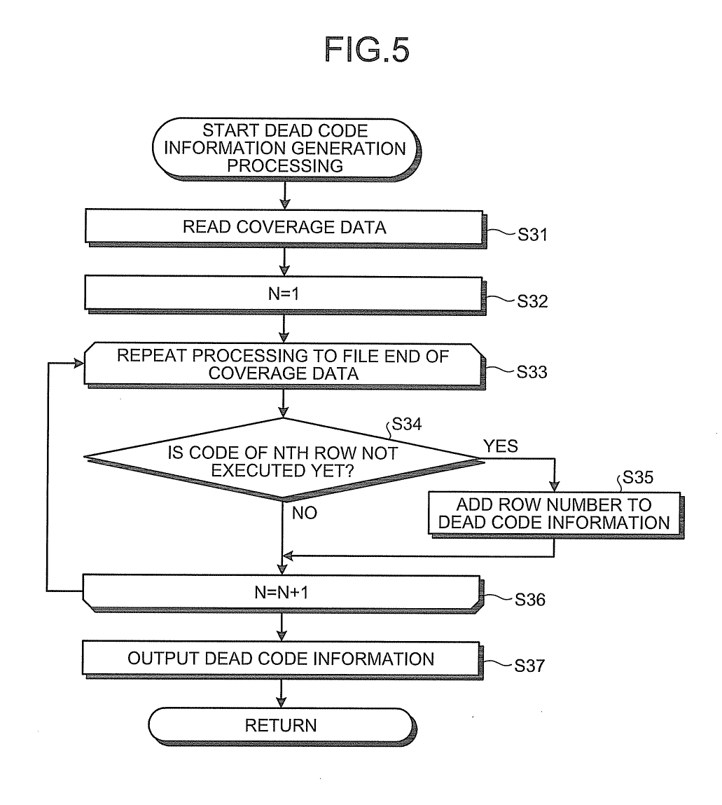

FIG. 5 is a flowchart for explaining the processing at step S12 more in detail. The dead-code-information generating unit 6 reads the coverage data D3 (S31). The dead-code-information generating unit 6 set a parameter N to 1 (S32). The dead-code-information generating unit 6 repeats the operation at steps S33 to S36 until an Nth row reaches the end of the coverage data D3. The dead-code-information generating unit 6 determines whether a code row in the Nth row is not executed yet (S34). When the code row is not executed yet (“Yes” at S34), the dead-code-information generating unit 6 adds the row number N of the code row to the dead code information D4 (S35). The dead-code-information generating unit 6 increments N by 1 (S36). When the code row is already executed (“No” at S34), the processing shifts to step S36.

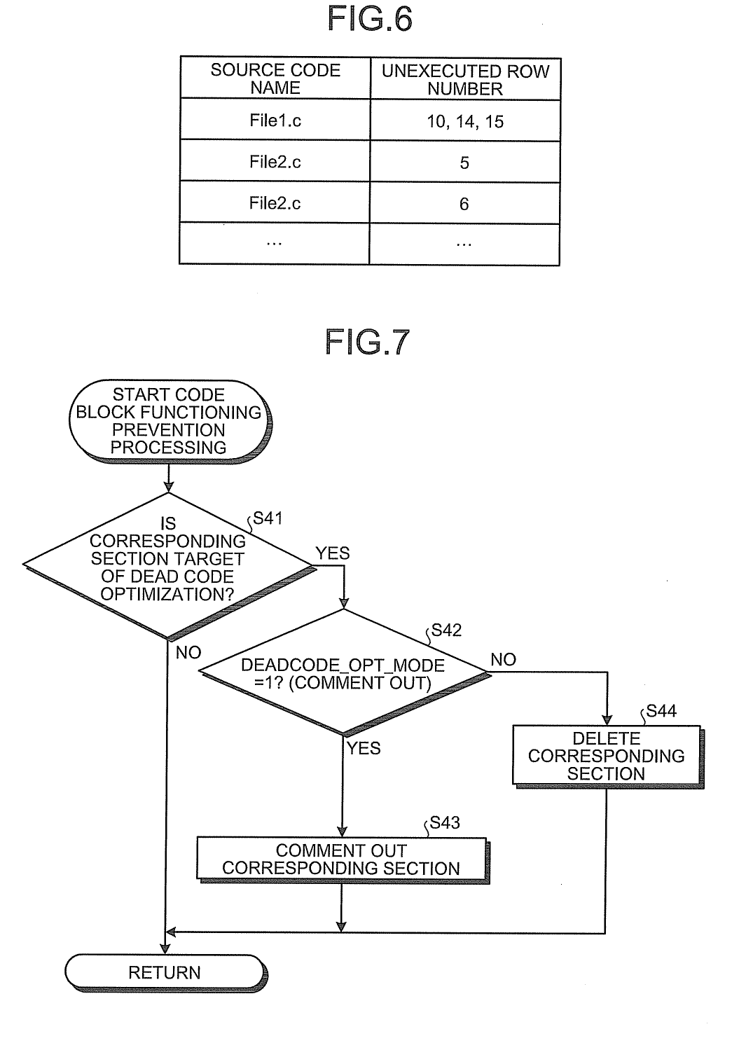

After the processing is executed to the end, the dead-code-information generating unit 6 outputs the dead code information D4 to the RAM 13 (S37) and the processing is returned. According to the operation at steps S31 to S37, the dead code information D4 including row numbers of tenth, fourteenth, and fifteenth rows is created from the coverage data D3 shown in FIG. 4. FIG. 6 is a diagram for explaining an example of the created dead code information D4. In the dead code information D4 shown in FIG. 6, row numbers of unexecuted rows are displayed as a list for each file included in the source code.

After step S12, the control shift to the coverage-data-acquisition instructing unit 2. The coverage-data acquisition instructing unit 2 determines again whether the coverage data acquisition instruction is included in the user command (S3). At the point of the determination for the second time, because the coverage data acquisition instruction is deleted from the user command at step S5, the processing shifts to step S13. The coverage-data-acquisition instructing unit 2 sets Makefile not added with the coverage acquisition option (S13).

The dead-code optimizing unit 3 expands the source code included in the input information D1 on the RAM 13 and analyzes the expanded source code (S14). The dead-code optimizing unit 3 reads the dead code information D4 (S15) and sets the parameter N to 1 (S16). The dead-code-optimizing unit 3 repeats the operation at steps S17 to S20 to the end of the dead code information file. The dead-code optimizing unit 3 reads an Nth item of the dead code information D4 (S18) and processes (comments out or deletes) a code block in the source code corresponding to the read item to prevent the code block from functioning (S19).

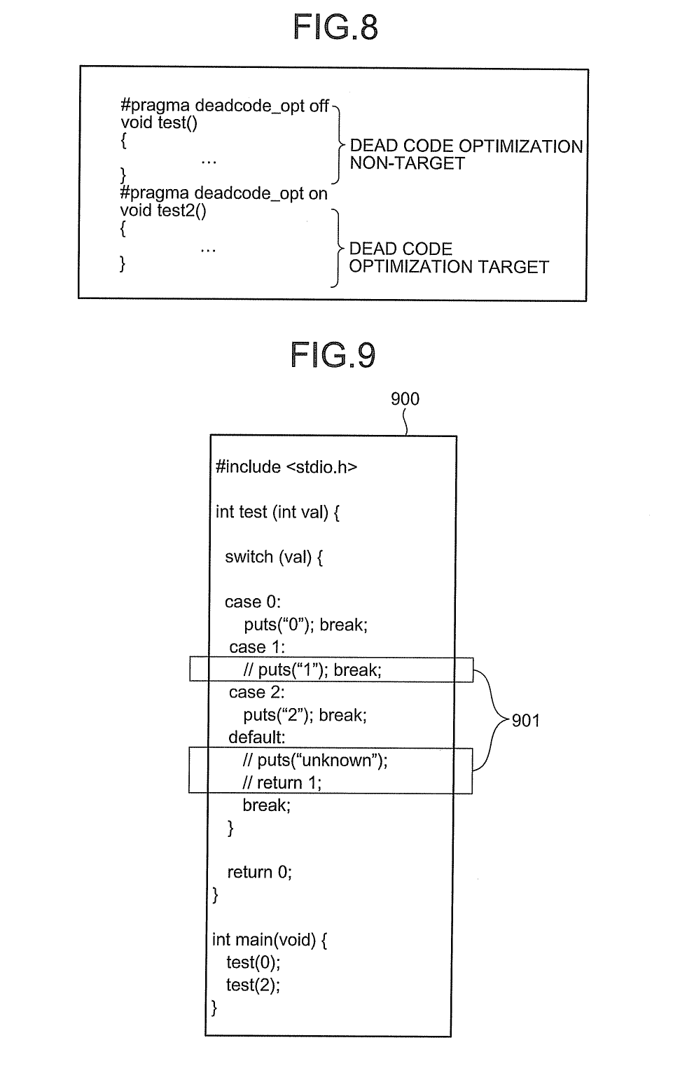

FIG. 7 is a flowchart for explaining the processing at step S19 more in detail. The dead-code optimizing unit 3 determines whether a section corresponding to the item in the source code read at step S18 is a dead code optimization object (S41). In the C language, a description #pragma for giving a special instruction to a compiler is prepared. In the first embodiment, #pragma is described in the source code to make it possible to designate, for each function, whether dead code optimization should be performed. Therefore, a flexible program environment is provided to the user. In this step, the dead-code optimizing unit 3 determines whether, immediately before a function including the corresponding section, the function is designated as a dead code optimization target or designated as a dead code optimization non-target by #pragma. When no designation is made, it is assumed that the function is designated as the dead code optimization target. For example, as shown in FIG. 8, when an instruction #pragma deadcode_opt is given, the dead-code optimizing unit 3 determines that a code block included in a function “test” immediately after the instruction is a dead code optimization non-target. When an instruction by a #pragma statement is not given or an instruction #pragma deadcode_opt on is given, the dead-code optimizing unit 3 determines that a code block included in a function “test2” immediately after the instruction is a dead code optimization target.

When the corresponding section is the dead code optimization target (“No” at S41), the processing is returned. When the corresponding section is the dead code optimization target (“Yes” at S41), the dead-code optimizing unit 3 further determines whether DEADCODE_OPT_MODE=1 as an option for instructing to comment out an invalid code block in a user command is designated (S42). When DEADCODE_OPT_MODE=1 is designated (“Yes” at S42), the dead-code optimizing unit 3 comments out the section (S43) and the processing is returned. When DEADCODE_OPT_MODE=1 is not designated (“No” at S42), i.e., when DEADCODE_OPT_MODE=2 is designated, the dead-code optimizing unit 3 deletes the corresponding section (S44) and the processing is returned.

After step S19, the dead-code optimizing unit 3 increments N by 1 (S20) and repeats the operation at steps S17 to S20 until a value of N reaches the file end of the dead code information D4. When the dead-code optimizing unit 3 leaves the repeated processing at steps S17 to S20, a source code subjected to dead code optimization is completed on the RAM 13.

FIG. 9 is an example of a source code subjected to dead code optimization obtained when DEADCODE_OPT_MODE=1 is designated. A source code 900 shown in FIG. 9 is adapted such that, when the invalid code blocks designated in the dead code information D4 shown in FIG. 4 is commented out (sections indicated by reference numeral 901 in the figure) and second compilation is performed in the following steps, an object code is not generated from the commented-out section.

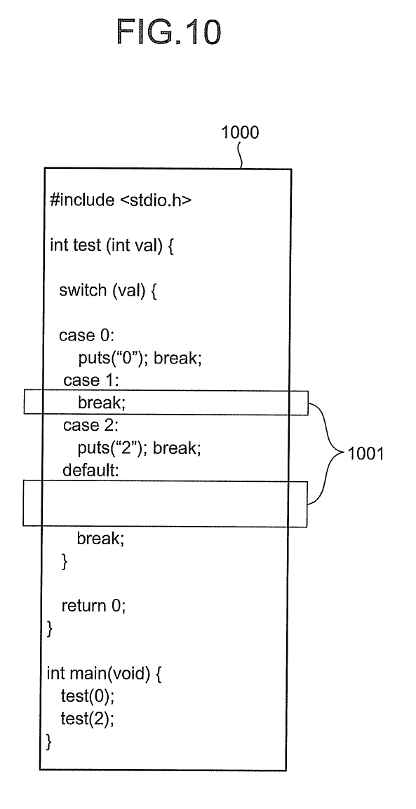

FIG. 10 is an example of a source code subjected to dead code optimization obtained when DEADCODE_OPT_MODE=2 is designated. A source code 1000 shown in FIG. 10 is adapted such that invalid code blocks are deleted (sections indicated by reference numeral 1001) and an execution program not including an object code not executed during the second compilation is generated. In the example of the source code 1000, rather than completely deleting a code row of a tenth row, a break instruction is left to leave case 2 as a branch destination described in a ninth row.

At steps S21 to S24, the second compilation is performed to generate the execution program subjected to dead code optimization D5 (a fourth stage). The second compilation is performed according to a procedure same as steps S7 to S9. Specifically, the compiler unit 4 generates an object code from a source code subjected to the dead code optimization processing stored on the RAM 13 (S21), optimizes the generated code (S22), and links a file necessary for execution with the optimized code (S23). The compiler unit 4 outputs the linked code as the execution program for dead code optimization D5 (S24) and ends the processing.

As explained above, according to the first embodiment, a source code is compiled, an execution program for outputting coverage data during execution is output, a code block not executed at all included in the source code is subjected to comment-out processing or deletion processing according to coverage data obtained by executing the output execution program to generate a source code subjected to dead code optimization, and the generated source code subjected to dead code optimization, whereby the execution program subjected to dead code optimization is output. Consequently, because dead code optimization according to a dynamic analysis can be executed, efficient compilation can be performed. It is possible to select according to an option in a user command whether an invalid instruction should be commented out or deleted. Therefore, the user can select comment-out or select deletion taking into account convenience during debag and can perform flexible programming.

In the above explanation, the code block functioning prevention processing for an input source code is executed on the RAM 13, the source code subjected to code block functioning prevention processing is compiled, and the execution program subjected to dead code optimization D5 is output. However, it is also possible to output the source code subjected to the code block functioning prevention processing to an external storage device or the like once and read the source code output to the external storage device again to execute the second compilation.

It is also possible to output dead code information to the external storage device, the display unit 14, or the like once before proceeding to the code block functioning prevention processing and inform the user of the presence and the position of the invalid code block. Further, it is also possible to urge the user to edit the output dead code information and proceed to processing for preventing a code block to function according to the edited dead code information.

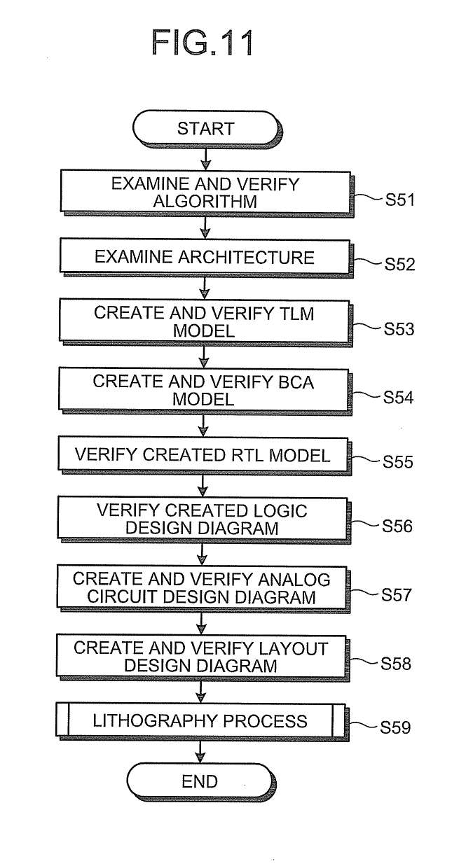

In recent years, in a design field of semiconductor integrated circuits, modeling of hardware is performed according to a programming language such as System C. FIG. 11 is a flowchart for explaining an example of a procedure for designing and manufacturing a semiconductor integrated circuit using the System C.

First, an algorithm to be realized is examined and verified by using the C language (S51). As the algorithm, image processing such as filtering or data compression/expansion, encryption/decryption, communication, and the like are conceivable. It is examined in what kind of system configuration, i.e., architecture the verified algorithm is realized (S52).

When it is determined which function is realized as hardware as a result of the architecture examination, by using the System C, a hardware hierarchy and an interface are defined for the algorithm to be realized as hardware. As a model of the hardware, for example, a transaction level modeling model that can verify a system at high speed without defining a detailed interface is used. The TLM model described in the System C is compiled and verification of the TLM model is performed by executing an obtained execution program (S53).

After the verification of the TLM model, a bus cycle accurate (BCA) model for defining a detailed interface is created and verified (S54). The BCA model is a model for defining input and output interfaces with pin accuracy. The BCA model described in the System C is compiled and an obtained execution program is executed, whereby the verification of the BCA model is performed.

When the verification of the BCA model ends, design limitation conditions and an option of scheduling are set in a behavior combining tool or the like, behavior combination is executed, and a register transfer level (RTL) model obtained by the behavior combination is verified (S55). When the RTL model satisfies a design target, the processing directly proceeds to logic combination, a logic design diagram as a circuit diagram including a digital element such as a gate circuit is created, and the created logic design diagram is verified (S56). An analog circuit design diagram is created according to the verified logic design diagram by using an analog element such as a transistor and the created analog circuit design diagram is verified (S57). A layout diagram of a mask pattern serving as a photomask original picture in an LSI process is created according to the verified analog circuit diagram, the created layout diagram is verified (S58), and a lithography process is executed according to the verified layout diagram to obtain a semiconductor integrated circuit (S59).

As explained above, in the design field of semiconductor integrated circuit, processes for compiling a design model described in a programming language and executing an output execution program to thereby perform verification of the design model such as steps S51, S53, and S54 is included in the procedure for designing and manufacturing an semiconductor integrated circuit. At least one of such processes can be realized by using the compile apparatus 10. Specifically, in the example explained above, an execution program for outputting coverage data from a design model including an algorithm described in the C language and a TLM model and a BCA model described in the System C is created, the created execution program is executed to acquire the coverage data, and the dead code optimization processing is applied to the design model according to the acquire coverage data. This makes it possible to remove an unnecessary design portion from the design model and obtain effects such as a reduction in an area in use of the design model and an increase in speed of operation. Further, only a design model subjected to dead code optimization is compiled again and an obtained execution file is executed. This makes it possible to execute verification of the design model subjected to dead code optimization.

In the above explanation, a semiconductor integrated circuit is manufactured by photolithography. However, even when a semiconductor integrated circuit is manufactured by using a process other than lithography such as nano-imprinting, it is possible to use the design model verified by using the compile apparatus 10.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A compile method comprising:
outputting a first execution program for outputting coverage data during execution by compiling a first source code;
outputting the coverage data by executing the output first execution program;
generating a second source code, according to the output coverage data, by commenting out or deleting a code block not executed at all included in the first source code; and
outputting a second execution program by compiling the generated second source code.

2. The compile method according to claim 1, wherein the generating a second source code includes:
outputting dead code information indicating the code block not executed at all included in the first source code; and
commenting out or deleting, according to the output dead code information, the code block not executed at all.

3. The compile method according to claim 1, further comprising receiving a user command including an option for designating whether the code block not executed at all should be commented out or deleted, wherein
the generating a second source code includes determining, according to the option included in the user command, whether the code block not executed at all included in the first source code should be commented out or deleted.

4. The compile method according to claim 1, wherein
the first source code includes an operation designating description for instructing, for each function, whether the code block not executed at all should be commented out nor deleted or should be neither commented out nor deleted, and
the generating a second source code includes determining, for each function, according to the operation designating description included in the first source code, whether the code block not executed at all should be commented out or deleted or should be neither commented out nor deleted.

5. The compile method according to claim 4, wherein the operation designating description is a description including #pragma.

6. A computer program product including a plurality of instructions executable by a computer, the instructions causing the computer to execute:
outputting a first execution program for outputting coverage data during execution by compiling a first source code;
outputting the coverage data by executing the output first execution program;
generating a second source code, according to the output coverage data, by commenting out or deleting a code block not executed at all included in the first source code; and
outputting a second execution program by compiling the generated second source code.

7. The computer program product according to claim 6, wherein the generating a second source code includes:
outputting dead code information indicating the code block not executed at all included in the first source code; and
commenting out or deleting, according to the output dead code information, the code block not executed at all.

8. The computer program product according to claim 6, further causing the computer to execute comprising receiving a user command including an option for designating whether the code block not executed at all should be commented out or deleted, wherein
the generating a second source code includes determining, according to the option included in the user command, whether the code block not executed at all included in the first source code should be commented out or deleted.

9. The computer program product according to claim 6, wherein
the first source code includes an operation designating description for instructing, for each function, whether the code block not executed at all should be commented out nor deleted or should be neither commented out nor deleted, and
the generating a second source code includes determining, for each function, according to the operation designating description included in the first source code, whether the code block not executed at all should be commented out or deleted or should be neither commented out nor deleted.

10. The computer program product according to claim 9, wherein the operation designating description is a description including #pragma.

11. A semiconductor-integrated-circuit manufacturing method comprising:
outputting a first execution program for outputting coverage data during execution by compiling a first design model for a semiconductor integrated circuit described in a programming language;
outputting the coverage data by executing the output first execution program;
generating a second design model, according to the output coverage data, by commenting out or deleting a code block not executed at all included in the first design model;
outputting a second execution program by compiling the generated second design model;
verifying the second design model by executing the output second execution program;
creating, according to the verified second design model, an analog circuit design diagram for the semiconductor integrated circuit; and
manufacturing the semiconductor integrated circuit according to the created analog circuit design.

12. The semiconductor-integrated-circuit manufacturing method according to claim 11, wherein the generating a second design model includes:
outputting dead code information indicating the code block not executed at all included in the first source code; and
commenting out or deleting, according to the output dead code information, the code block not executed at all.

13. The semiconductor-integrated-circuit manufacturing method according to claim 11, further comprising receiving a user command including an option for designating whether the code block not executed at all should be commented out or deleted, wherein
the generating a second design model includes determining, according to the option included in the user command, whether the code block not executed at all included in the first design model should be commented out or deleted.

14. The semiconductor-integrated-circuit manufacturing method according to claim 11, wherein
the first design model includes an operation designating description for instructing, for each function, whether the code block not executed at all should be commented out nor deleted or should be neither commented out nor deleted, and
the generating a second design model includes determining, for each function, according to the operation designating description included in the first source code, whether the code block not executed at all should be commented out or deleted or should be neither commented out nor deleted.

15. The semiconductor-integrated-circuit manufacturing method according to claim 14, wherein the operation designating description is a description including #pragma.

16. The semiconductor-integrated-circuit manufacturing method according to claim 11, wherein the first and second design models are transaction level modeling (TLM) models.

17. The semiconductor-integrated-circuit manufacturing method according to claim 11, the first and second design models are bus cycle accurate (BCA) models.

18. The semiconductor-integrated-circuit manufacturing method according to claim 11, wherein the manufacturing a semiconductor integrated circuit includes:
generating a mask layout diagram according to the created analog circuit design diagram; and
executing a lithograph process according to the generated mask layout diagram.
